(19) United States
(12) Patent Application Publication
(10) Pub. No.: US 2025/0004113 A1
(43) Pub. Date: Jan. 2, 2025

(54) DISTANCE IMAGE CAPTURING DEVICE AND DISTANCE IMAGE CAPTURING METHOD

(71) Applicant: TOPPAN Holdings Inc., Tokyo (JP)

(72) Inventors: Takahiro AKUTSU, Tokyo (JP); Kazuto YAMAMOTO, Tokyo (JP); Takeshi KAWABATA, Tokyo (JP); Yuya SHIRAKAWA, Tokyo (JP)

(73) Assignee: TOPPAN Holdings Inc., Tokyo (JP)

(21) Appl. No.: 18/754,289

(22) Filed: Jun. 26, 2024

(30) Foreign Application Priority Data
Jun. 30, 2023 (JP) 2023-108745

(51) Int. Cl. G01S 7/487; G01S 7/4863; G01S 7/4865; G01S 17/894

(52) U.S. Cl. CPC G01S 7/4876; G01S 7/4863; G01S 7/4865; G01S 17/894

(57) ABSTRACT

In a distance image capturing device, the frame cycle includes an accumulation period in which reflected light of the optical pulse is accumulated in the charge accumulation unit, a first output period in which a first voltage value corresponding to the amount of charges accumulated in the charge accumulation unit in the accumulation period is output, an FPN measurement period in which a fixed pattern noise accumulated in the charge accumulation unit is measured, a second output period in which a second voltage value corresponding to the amount of charges accumulated in the charge accumulation unit in the FPN measurement period is output, and a readout period in which a differential signal corresponding to a difference between the first voltage value and the second voltage value is output, and the distance calculation unit calculates the distance to the subject using a signal value of the differential signal.

### CROSS REFERENCE TO RELATED APPLICATIONS

This application is a continuation application based on Japanese Patent Application No. 2023-108745, filed on Jun. 30, 2023.

### BACKGROUND OF THE INVENTION

### Field of the Invention

The present invention relates to a distance image capturing device and a distance image capturing method.

### Description of Related Art

A time of flight (hereinafter, referred to as “TOF”) type distance image capturing device has been implemented that uses a known speed of light and measures the distance between a measuring instrument and an object based on a flight time of light in space (measurement space) (for example, refer to Japanese Patent No. 4235729).

When the measurement is performed with such a distance image capturing device, fixed pattern noise (FPN) which is an error due to a circuit configuration and the like may occur and be mixed into the accumulated signal. Therefore, for example, there is a countermeasure that calculates the distance after performing a correction (FPN correction) by subtracting the FPN measured in advance from the accumulated signal at the time of measurement.

### SUMMARY OF THE INVENTION

However, the FPN may fluctuate depending on the situation of the distance image capturing device. For example, the FPN fluctuates due to a difference in temperature in the device between immediately after the distance image capturing device is started and after a certain period has passed since the startup. In addition, in a case where a variable related to the measurement, such as the number of times of integration, is changed, the FPN fluctuates due to a change in the amount of heat generated in the device or the accumulation time. When the FPN fluctuates, it becomes difficult to accurately calculate the distance by correction using the FPN measured in advance.

As a countermeasure, it is considered to measure the FPN in advance for each of a plurality of measurement conditions such as the number of times of integration, since it is necessary to measure for each of a large number of measurement conditions, which is troublesome. In addition, since a memory capacity for storing the measured large number of FPNs together with the measurement conditions is also required, the method is not realistic. Therefore, in a mode in which measurements are performed such as the number of times of integration is frequently changed, such as when performing auto exposure (AE, automatic exposure adjustment), there is a possibility that FPN correction may not function.

The present invention has been made based on the above problems, and an object thereof is to provide a distance image capturing device and a distance image capturing method capable of accurately calculating the distance even in a case where an FPN fluctuates depending on a situation of the device.

According to an aspect of the present disclosure, a distance image capturing device includes a light source unit configured to irradiate a subject with an optical pulse, a light receiving unit configured to include a pixel circuit in which a plurality of pixels, each of which has a photoelectric conversion element configured to generate a charge according to incident light, a charge discharge unit configured to discharge the charge, and a plurality of charge accumulation units configured to accumulate the charge, are arranged in a two-dimensional matrix shape, and a pixel driving circuit configured to distribute and accumulate the charge in each of the charge accumulation units at an accumulation timing synchronized with an irradiation with the optical pulse in a frame cycle, and discharge the charge to the charge discharge unit in a period other than the accumulation timing, and a distance calculation unit configured to calculate a distance to the subject based on an amount of charges accumulated in each of the charge accumulation units. The frame cycle includes an accumulation period in which reflected light of the optical pulse is accumulated in the charge accumulation unit, a first output period in which a first voltage value corresponding to the amount of charges accumulated in the charge accumulation unit in the accumulation period is output, an FPN measurement period in which a fixed pattern noise accumulated in the charge accumulation unit is measured, a second output period in which a second voltage value corresponding to the amount of charges accumulated in the charge accumulation unit in the FPN measurement period is output, and a readout period in which a differential signal corresponding to a difference between the first voltage value and the second voltage value is output, and the distance calculation unit calculates the distance to the subject using a signal value of the differential signal.

According to another aspect of the present disclosure, a distance image capturing method is performed by a distance image capturing device including a light source unit configured to irradiate a subject with an optical pulse, a light receiving unit configured to include a pixel circuit in which a plurality of pixels, each of which has a photoelectric conversion element configured to generate a charge according to incident light, a charge discharge unit configured to discharge the charge, and a plurality of charge accumulation units configured to accumulate the charge, are arranged in a two-dimensional matrix shape, and a pixel driving circuit configured to distribute and accumulate the charge in each of the charge accumulation units at an accumulation timing synchronized with an irradiation with the optical pulse in a frame cycle, and discharge the charge to the charge discharge unit in a period other than the accumulation timing, and a distance calculation unit configured to calculate the distance to the subject based on the amount of charges accumulated in each of the charge accumulation units, in which the frame cycle includes an accumulation period in which reflected light of the optical pulse is accumulated in the charge accumulation unit, a first output period in which a first voltage value corresponding to the amount of charges accumulated in the charge accumulation unit in the accumulation period is output, an FPN measurement period in which a fixed pattern noise accumulated in the charge accumulation unit is measured, a second output period in which a second voltage value corresponding to the amount of charges accumulated in the charge accumulation unit in the FPN measurement period is output, and a readout period in which a differential signal corresponding to a difference between the first voltage value and the second voltage value is output, the distance image capturing method includes via the distance calculation unit, calculating the distance to the subject using a signal value of the differential signal.

According to the present invention, it is possible to calculate the distance with high accuracy even in a case where the FPN fluctuates depending on the situation of the device.

### BRIEF DESCRIPTION OF THE DRAWINGS

FIG. 1 is a block diagram showing a schematic configuration of a distance image capturing device 1 according to an embodiment.

FIG. 2 is a block diagram showing a schematic configuration of a distance image sensor 32 according to the embodiment.

FIG. 3 is a circuit diagram showing an example of a configuration of a pixel 321 according to the embodiment.

FIG. 4 is a diagram showing a frame cycle according to the embodiment.

FIG. 5 is a diagram showing processing performed by the distance image capturing device 1 according to the embodiment.

FIG. 6 is a table showing processing performed by the distance image capturing device 1 according to the embodiment.

FIG. 7 is a flowchart showing a flow of processing performed by the distance image capturing device 1 according to the embodiment.

### DETAILED DESCRIPTION OF THE INVENTION

Hereinafter, a distance image capturing device according to the embodiment will be described with reference to the drawings.

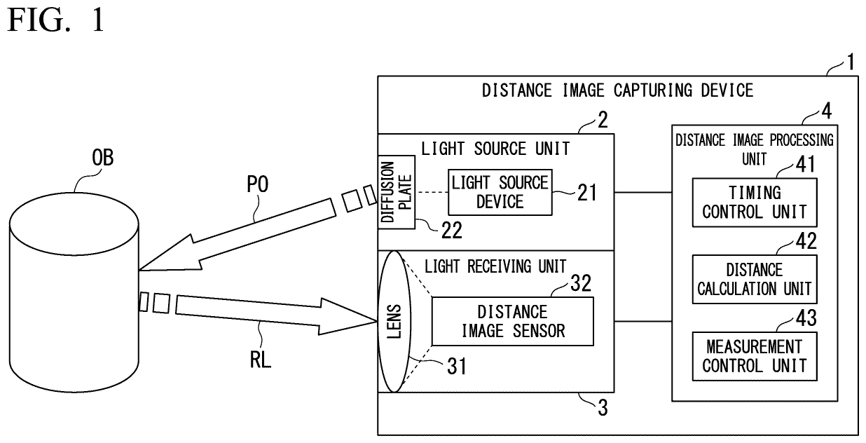

FIG. 1 is a block diagram showing a schematic configuration of a distance image capturing device according to the embodiment. A distance image capturing device 1 includes, for example, a light source unit 2, a light receiving unit 3, and a distance image processing unit 4. FIG. 1 also shows a subject OB, which is an object for measuring the distance in the distance image capturing device 1.

The light source unit 2 irradiates a space to be measured in which the subject OB is present with an optical pulse PO in accordance with the control from the distance image processing unit 4. The light source unit 2 is, for example, a surface emitting semiconductor laser module such as a vertical cavity surface emitting laser (VCSEL). The light source unit 2 includes a light source device 21 and a diffusion plate 22.

The light source device 21 is a light source that emits laser light in a near-infrared wavelength band (for example, a wavelength band with a wavelength of 850 nm to 940 nm) as the optical pulse PO which is emitted to the subject OB. The light source device 21 is, for example, a semiconductor laser light emitting element. The light source device 21 emits pulsed laser light in accordance with the control of a timing control unit 41.

The diffusion plate 22 is an optical component that diffuses the laser light in the near-infrared wavelength band emitted by the light source device 21 to a size of a surface for emitting to the subject OB. The pulsed laser light diffused by the diffusion plate 22 is emitted as the optical pulse PO, and emitted to the subject OB.

The light receiving unit 3 receives reflected light RL of the optical pulse PO reflected by the subject OB to which a distance is to be measured in the distance image capturing device 1, and outputs a pixel signal according to the received reflected light RL. The light receiving unit 3 includes a lens 31 and a distance image sensor 32.

The lens 31 is an optical lens that guides the incident reflected light RL to the distance image sensor 32. The lens 31 emits the incident reflected light RL to the distance image sensor 32 side, and causes the reflected light RL to be received (incident) on the pixels provided in the light receiving region of the distance image sensor 32.

The distance image sensor 32 is an image capturing element used in the distance image capturing device 1. The distance image sensor 32 includes a plurality of pixels arranged in a two-dimensional matrix shape. In each of the pixels of the distance image sensor 32, one photoelectric conversion element, a plurality of charge accumulation units corresponding to the one photoelectric conversion element, and a component that distributes charges to each of the charge accumulation units are provided. That is, the pixel is the image capturing element having a distribution configuration in which the charges are distributed and accumulated in the plurality of charge accumulation units.

The distance image sensor 32 distributes the charges generated by the photoelectric conversion element to each of the charge accumulation units, in accordance with control from the timing control unit 41. In addition, the distance image sensor 32 outputs a pixel signal corresponding to the amount of charges distributed to the charge accumulation units. In the distance image sensor 32, a plurality of pixels are arranged in a two-dimensional matrix, and a pixel signal for one frame corresponding to each of the pixels is output.

The distance image processing unit 4 controls the distance image capturing device 1, and calculates the distance to the subject OB. The distance image processing unit 4 includes a timing control unit 41, a distance calculation unit 42, and a measurement control unit 43.

The timing control unit 41 controls the timing of outputting various control signals required for measurement in accordance with the control of the measurement control unit 43. The various control signals here include, for example, a signal that controls the emission of the optical pulse PO, a signal that distributes the reflected light RL to the plurality of charge accumulation units and accumulates the reflected light RL, a signal that controls the number of times of integration per frame, and the like. The number of times of integration is the number of times of repeating the processing of distributing and accumulating charges in the charge accumulation unit.

The distance calculation unit 42 calculates the distance to the subject OB based on the pixel signal output from the distance image sensor 32, and outputs the calculated distance. The distance calculation unit 42 calculates a delay time from the irradiation with the optical pulse PO to the reception of the reflected light RL based on the amount of charges accumulated in the plurality of charge accumulation units, and calculates the distance to the subject OB in accordance with the calculated delay time.

The measurement control unit 43 controls the timing control unit 41. For example, the measurement control unit 43 sets the number of times of integration of one frame or the like and controls the timing control unit 41 such that an image is captured with the set contents.

With such a configuration, in the distance image capturing device 1, the light receiving unit 3 receives the reflected light RL in which the optical pulse PO in the near-infrared wavelength band emitted to the subject OB by the light source unit 2 is reflected by the subject OB, and the distance image processing unit 4 outputs distance information obtained by measuring the distance to the subject OB.

Although FIG. 1 shows the distance image capturing device 1 having a configuration in which the distance image processing unit 4 is provided inside the distance image capturing device 1, the distance image processing unit 4 may be a component provided outside the distance image capturing device 1.

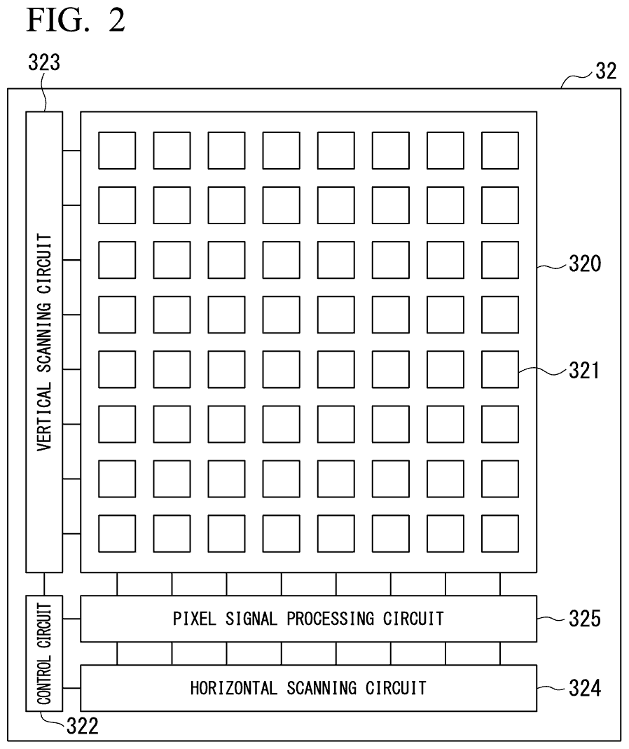

Here, the configuration of the distance image sensor 32 will be described with reference to FIG. 2. FIG. 2 is a block diagram showing a schematic configuration of the image capturing element (distance image sensor 32) used in the distance image capturing device 1 according to the embodiment.

As shown in FIG. 2, the distance image sensor 32 includes, for example, a light receiving region 320 in which a plurality of pixels 321 are arranged, a control circuit 322, a vertical scanning circuit 323 with a distribution operation, a horizontal scanning circuit 324, and a pixel signal processing circuit 325.

The light receiving region 320 is a region in which the plurality of pixels 321 are arranged, and FIG. 2 shows an example in which the plurality of pixels 321 are arranged in a two-dimensional matrix in eight rows and eight columns. The pixels 321 accumulate charges corresponding to the amount of light received. The control circuit 322 generally controls the distance image sensor 32. For example, the control circuit 322 controls the operations of the components of the distance image sensor 32 in response to an instruction from the timing control unit 41 of the distance image processing unit 4. The components provided in the distance image sensor 32 may be controlled directly by the timing control unit 41, and in this case, the control circuit 322 can also be omitted.

The vertical scanning circuit 323 is a circuit that controls the pixels 321 arranged in the light receiving region 320 for each row in accordance with the control from the control circuit 322. The vertical scanning circuit 323 outputs a voltage signal according to the amount of charges accumulated in each of the charge accumulation units CS of the pixel 321 to the pixel signal processing circuit 325. For example, the vertical scanning circuit 323 distributes and accumulates the charges converted by the photoelectric conversion element in each of the charge accumulation units of the pixels 321 at the accumulation timing synchronized with the irradiation with the optical pulse PO. In addition, the vertical scanning circuit 323 discharges the charges converted by the photoelectric conversion element from a charge discharge unit (a drain gate transistor GD described later) in a period different from the accumulation timing. In this case, the vertical scanning circuit 323 is an example of a “pixel driving circuit”.

The pixel signal processing circuit 325 is a circuit that performs a predetermined signal processing (for example, noise suppression processing, A/D conversion processing, or the like) on the voltage signal output to the corresponding vertical signal line from the pixels 321 in each of the columns in accordance with the control from the control circuit 322.

The horizontal scanning circuit 324 is a circuit that sequentially outputs the signals output from the pixel signal processing circuit 325 to a horizontal signal line in accordance with the control from the control circuit 322. As a result, a pixel signal corresponding to the amount of charges accumulated for one frame is sequentially output to the distance image processing unit 4 via the horizontal signal line.

Hereinafter, it is assumed that the pixel signal processing circuit 325 performs the A/D conversion processing and the pixel signal is a digital signal.

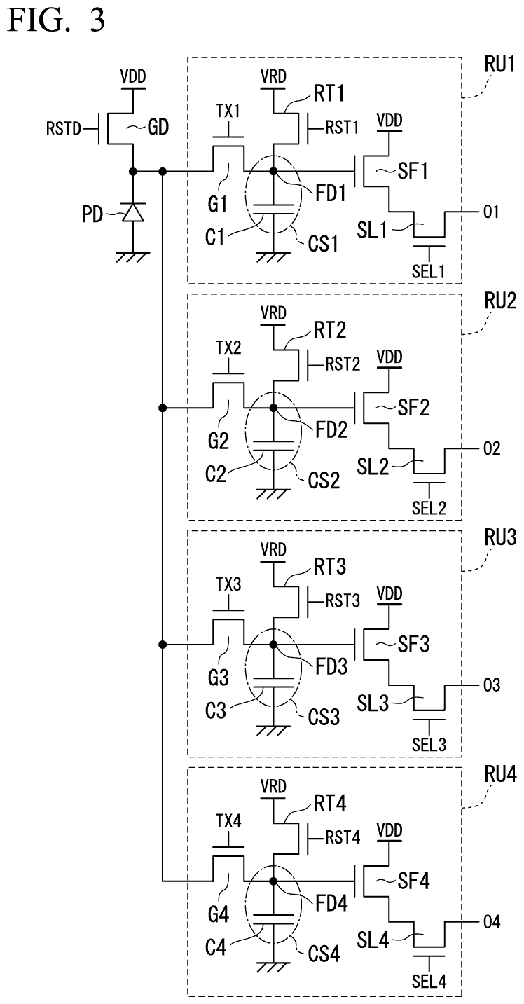

Here, the configuration of the pixel 321 will be described with reference to FIG. 3. FIG. 3 is a circuit diagram showing an example of a configuration of the pixels 321 arranged in the light receiving region 320 of the distance image sensor 32 according to the embodiment. FIG. 3 shows an example of the configuration of one pixel 321 among the plurality of pixels 321 arranged in the light receiving region 320. The pixel 321 is an example of a configuration including four pixel signal readout units.

The pixel 321 includes one photoelectric conversion element PD, a drain gate transistor GD, and four pixel signal readout units RU for outputting voltage signals from corresponding output terminals O. Each of the pixel signal readout units RU includes a readout gate transistor G, a floating diffusion FD, a charge accumulation capacitor C, a reset gate transistor RT, a source follower gate transistor SF, and a selection gate transistor SL. In each of the pixel signal readout units RU, the floating diffusion FD and the charge accumulation capacitor C constitute the charge accumulation unit CS.

In FIG. 3, each of the pixel signal readout units RU is distinguished by adding any number “1” to “4” after the symbol “RU” of the four pixel signal readout units RU. In addition, similarly, for each component provided in each of the four pixel signal readout units RU, a number indicating each of the pixel signal readout units RU is added after the symbol to distinguish and indicate the pixel signal readout unit RU corresponding to each component.

In the pixel 321 shown in FIG. 3, a pixel signal readout unit RU1 that outputs a voltage signal from an output terminal O1 includes a readout gate transistor G1, a floating diffusion FD1, a charge accumulation capacitor C1, a reset gate transistor RT1, a source follower gate transistor SF1, and a selection gate transistor SL1. In the pixel signal readout unit RU1, the floating diffusion FD1 and the charge accumulation capacitor C1 constitute the charge accumulation unit CS1. The pixel signal readout units RU2 to RU4 also have the same configuration.

The photoelectric conversion element PD is an embedded photodiode that photoelectrically converts incident light to generate a charge and accumulates the generated charges. The photoelectric conversion element PD may have any structure. The photoelectric conversion element PD may be, for example, a PN photodiode having a structure in which a P-type semiconductor and an N-type semiconductor are bonded together, or a PIN photodiode having a structure in which an I-type semiconductor is interposed between a P-type semiconductor and an N-type semiconductor. In addition, the photoelectric conversion element PD is not limited to the photodiode, and may be, for example, a photogate type photoelectric conversion element.

In the pixel 321, the charges generated by the photoelectric conversion of incident light by the photoelectric conversion element PD are distributed to each of the four charge accumulation units CS, and each of the voltage signals corresponding to the amount of charges of the distributed charges is output to the pixel signal processing circuit 325.

The configuration of the pixels arranged in the distance image sensor 32 is not limited to the configuration including the four pixel signal readout units RU as shown in FIG. 3, and may be any pixel having a configuration including a plurality of pixel signal readout units RU. That is, the number of pixel signal readout units RU (charge accumulation units CS) provided in the pixels arranged in the distance image sensor 32 may be two, three, or five or more.

In addition, in the pixel 321 having the configuration shown in FIG. 3, an example in which the charge accumulation unit CS includes a floating diffusion FD and a charge accumulation capacitor C is shown. However, the charge accumulation unit CS may include at least the floating diffusion FD, and the pixel 321 may not include the charge accumulation capacitor C.

In addition, in the pixel 321 having the configuration shown in FIG. 3, although an example of the configuration including the drain gate transistor GD is shown, in a case where it is not necessary to discard the charges accumulated (remaining) in the photoelectric conversion element PD, the drain gate transistor GD may not be provided. The drain gate transistor GD is an example of a “charge discharge unit”.

Here, when the measurement is performed by the distance image capturing device 1, certain fixed pattern noise (FPN) caused by circuit characteristics, signal processing, and the like may be mixed into the accumulated signal. Furthermore, depending on the situation of the distance image capturing device 1, the magnitude of the FPN may fluctuate, for example, immediately after the distance image capturing device is started and after a certain period has passed since the startup.

As a countermeasure, in the present embodiment, in one frame cycle, a period (FPN measurement period in the present embodiment) for measuring the FPN is provided in addition to a normal exposure period (accumulation period in the present embodiment). By providing the accumulation period and the FPN measurement period in one frame cycle, FPN according to the current situation in the distance image capturing device 1 can be measured, and the accumulated signal can be corrected by using the measured FPN. Even in a case where the FPN fluctuates, the accumulated signal can be corrected by using the FPN after fluctuation, and thus the distance can be calculated with high accuracy.

Any method can be adopted as a method of subtracting the FPN from the accumulated signal. For example, in the distance image capturing device 1, correlated double sampling (CDS) that is a method of reducing thermal noise accompanied by the reading of the pixels 321 can be used.

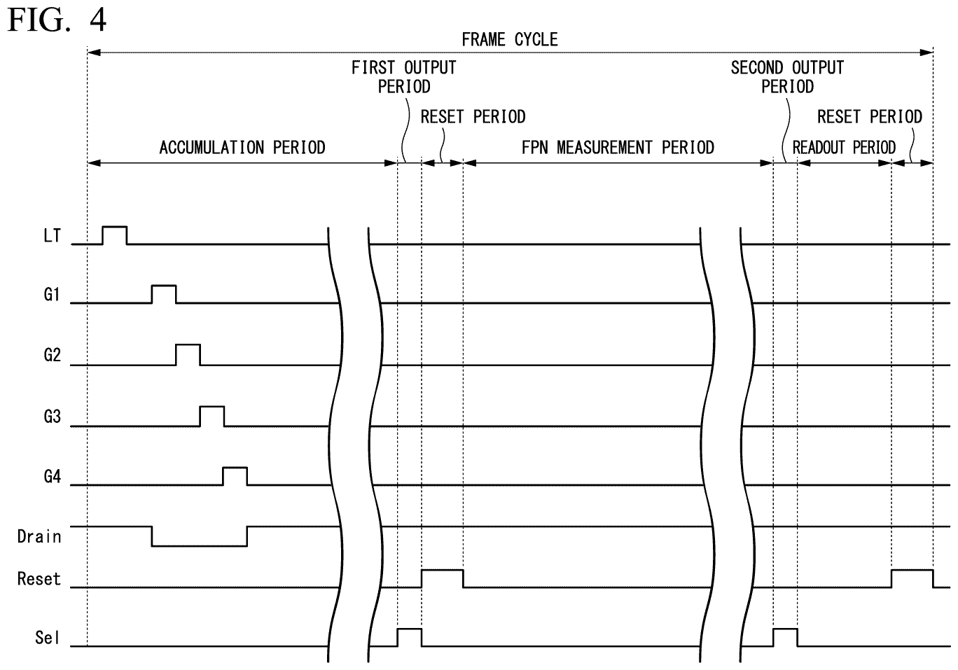

Here, the frame cycle of the embodiment will be described with reference to FIG. 4. FIG. 4 is a diagram showing a frame cycle of the embodiment. FIG. 4 shows a breakdown of processing of driving per frame and a timing chart corresponding to the breakdown as the frame cycle.

In this figure, timing charts of elements corresponding to each of the items of “L1”, “G1” to “G4”, “Drain”, “Reset”, and “Sel” are shown. The term “L1” indicates an emission timing with the optical pulse PO, light is emitted when the optical pulse PO is turned on, and no light is emitted when the optical pulse PO is turned off. The terms “G1” to “G4” indicate the driving timing of the readout gate transistors G1 to G4, the charges are accumulated when the readout gate transistors G1 to G4 are turned on, and the charges are not accumulated when the readout gate transistors G1 to G4 are turned off. The term “Drain” indicates the driving timing of the drain gate transistor GD, and the charges are discharged when the drain gate transistor GD is turned on, and the charges are not discharged when the drain gate transistor GD is turned off. The term “Reset” indicates the driving timing of the reset gate transistor RT, and the charges accumulated in the charge accumulation unit CS are reset by the discharge when the reset gate transistor RT is turned on, and the accumulated state is maintained without being reset when the reset gate transistor RT is turned off. The term “Sel” indicates the driving timing of the selection gate transistor SL, and the pixel signal readout unit RU is selected when the selection gate transistor SL is turned on, and the pixel signal readout unit RU is not selected when the selection gate transistor SL is turned off.

As shown in FIG. 4, the frame cycle is configured, for example, by driving the accumulation period, the first output period, the reset period, the FPN measurement period, the second output period, the readout period, and the reset period in this order.

The accumulation period is a period in which the optical pulse PO is emitted and the reflected light RL is received to accumulate the charges corresponding to the reflected light RL. In the accumulation period, the drain gate transistor GD is turned off and the readout gate transistors G1 to G4 are turned on in order at a timing synchronized with the timing when the optical pulse PO is emitted. As a result, the charges photoelectrically converted by the photoelectric conversion element PD are accumulated in the charge accumulation units CS1 to CS4 while each of the readout gate transistors G1 to G4 is controlled to be in the on state. The drain gate transistor GD is turned on to discharge the charges at a timing when the readout gate transistor G4 is in the off state. As a result, the charges photoelectrically converted by the photoelectric conversion element PD are discarded through the drain gate transistor GD. In the accumulation period, the driving of accumulating the reflected light RL accompanied by the emission is repeatedly executed by a predetermined number of times of integration.

The first output period is a period in which the accumulated signal corresponding to the charge accumulated in each of the charge accumulation units CS is stored in a storage unit (memory) provided in the distance image capturing device 1 in the accumulation period. In the first output period, the selection gate transistor SL is turned on, and a voltage (analog value) corresponding to the amount of charges accumulated in the charge accumulation units CS1 to CS4 is output from the output terminals O1 to O4 to the pixel signal processing circuit 325. The pixel signal processing circuit 325 stores each of the analog values output from the output terminals O1 to O4 in the memory as an accumulated signal.

The reset period is a period in which the reset gate transistor RT is turned on, the charges accumulated in the charge accumulation unit CS are discharged, and the reset is performed.

The FPN measurement period is a period in which only the FPN is accumulated in the charge accumulation unit CS. In the FPN measurement period, for example, the optical pulse PO is not emitted, and the drain gate transistor GD is normally turned on.

The second output period is a period in which the FPN signal corresponding to the charges accumulated in each of the charge accumulation units CS is stored in the storage unit (memory) provided in the distance image capturing device 1 in the FPN measurement period. In the second output period, similarly to the first output period, the selection gate transistor SL is turned on and a voltage (analog value) corresponding to the amount of charges accumulated in the charge accumulation units CS1 to CS4 is output from the output terminals O1 to O4 to the pixel signal processing circuit 325. The pixel signal processing circuit 325 stores each of the analog values output from the output terminals O1 to O4 in the memory as the FPN signal.

The readout period is a period in which a differential signal obtained by subtracting the FPN signal from the accumulated signal is output. The pixel signal processing circuit 325 acquires the accumulated signal stored in the memory in the first output period. The pixel signal processing circuit 325 acquires the FPN signal stored in the memory in the second output period. The pixel signal processing circuit 325 outputs a value obtained by converting an analog value obtained by subtracting the FPN signal from the accumulated signal into a digital value through A/D conversion processing as a differential signal.

The differential signal output in the readout period is used to calculate the distance to the subject OB. The distance D to the subject OB can be calculated using, for example, following Equation (1). Equation (1) shows an example of a case where charges corresponding to the external light are accumulated in the charge accumulation unit CS1, charges corresponding to the external light are accumulated in the charge accumulation units CS2 and CS3, and charges corresponding to the reflected light RL are accumulated across the charge accumulation units CS2 and CS3.

$$D = ( Q 3 - Q 1 ) / ( Q 2 + Q 3 - 2 Q 1 ) \times c / 2 \times Tw + c / 2 \times Tc \qquad ( 1 )$$

Here, D indicates the distance to the subject OB.

Q1 indicates a signal value obtained by excluding the FPN from the amount of charges accumulated in the charge accumulation unit CS1.

Q2 indicates a signal value obtained by excluding the FPN from the amount of charges accumulated in the charge accumulation unit CS2.

Q3 indicates a signal value obtained by excluding the FPN from the amount of charges accumulated in the charge accumulation unit CS3.

The symbol c indicates the speed of light.

The symbol Tw indicates a time width in which the optical pulse PO is emitted.

The symbol Tc indicates a time difference from the irradiation with the optical pulse PO to a time when the readout gate transistor G2 is set to the on state.

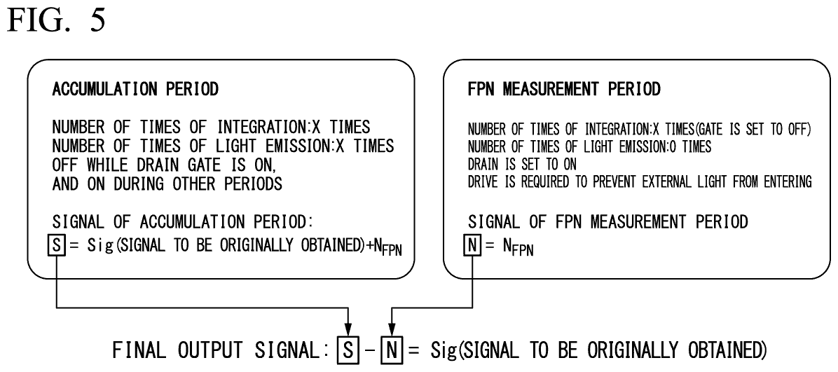

Here, the relationship between the accumulation period and the FPN measurement period will be described with reference to FIG. 5. FIG. 5 is a diagram showing processing performed by the distance image capturing device 1 according to the embodiment. FIG. 5 shows a breakdown of the driving in the accumulation period and the FPN measurement period.

As shown in FIG. 5, the number of times of integration and the number of times of light emission in the accumulation period are set to the same number of times (here, X times). In addition, the “Drain” in the accumulation period, that is, the driving timing of the drain gate transistor GD is set to the off state (Off) while any of the readout gate transistors G1 to G4 is set to the on state (Gate On). Other than that, that is, while all the readout gate transistors G1 to G4 are set to the off state, the driving timing of the drain gate transistor GD is set to the on state (On). The signal in the accumulation period, that is, the signal value S stored in the memory in the first output period is, for example, indicated by following Equation (2).

$$S = Sig + {N}_{FPN} \qquad ( 2 )$$

Here, S is a signal value corresponding to the amount of charges accumulated in the accumulation period,

Sig is a signal value corresponding to the amount of light received by the pixel 321 (signal value to be originally obtained), and N_{FPN} is a signal value corresponding to the fixed pattern noise (FPN).

On the other hand, the number of times of integration in the FPN measurement period is set to the same number of times (here, X times) as that in the accumulation period. Here, the gate is set to Off, and all the readout gate transistors G1 to G4 are set to the off state. The number of times of light emission in the FPN measurement period is 0 (zero). In addition, “Drain” in the FPN measurement period, that is, the drain gate transistor GD is set to the on state (On). Here, all the readout gate transistors G1 to G4 are set to the off state so that the charge corresponding to the external light is not accumulated in the charge accumulation unit CS, and the drain gate transistor GD is set to the on state (On). The signal in the FPN measurement period, that is, the signal value N stored in the memory in the second output period is, for example, indicated by following Equation (3).

$$N = {N}_{FPN} \qquad ( 3 )$$

Here, N_{FPN} is a signal value corresponding to the fixed pattern noise (FPN).

(S−N=Sig) can be output as the final output signal, that is, the differential signal output in the readout period. Therefore, it is possible to obtain a signal value Sig corresponding to the amount of light received by the pixels 321, which is a signal to be originally obtained.

As described above, in the frame cycle, the length of time in the FPN measurement period is set to the same length as the length of time in the accumulation period. As a result, the noise amount (N_{FPN}) of the fixed pattern noise accumulated in the charge accumulation unit CS in the accumulation period and the noise amount (N_{FPN}) of the fixed pattern noise accumulated in the charge accumulation unit CS in the FPN measurement period can be made equal to each other. Therefore, it is possible to remove the noise amount (N_{FPN}) of the fixed pattern noise included in the amount of charges (Sig+N_{FPN}) accumulated in the charge accumulation unit CS in the accumulation period by a simple calculation (subtraction) of (S−N).

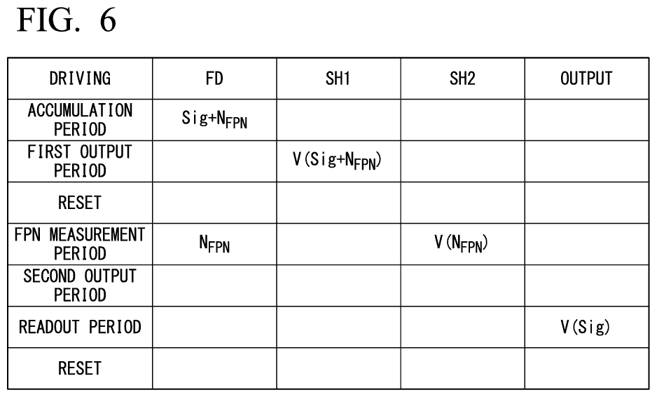

Here, the relationship between the driving in each period in the frame cycle and the signal value to be held or output will be described with reference to FIG. 6. FIG. 6 is a table showing processing performed by the distance image capturing device 1 according to the embodiment.

The vertical axis of FIG. 6 shows, as each period in the frame cycle, each of the accumulation period, the first output period, the reset period, the FPN measurement period, the second output period, the readout period, and the reset period. The horizontal axis of FIG. 6 shows, as elements in which the signal is held or output as a result of driving each period in the frame cycle, each of floating diffusion (FD), shift register 1 (SH1), shift register 2 (SH2), and output.

As shown in FIG. 6, in the accumulation period, the amount of charges (Sig+N_{FPN}) corresponding to the signal value S are accumulated in the FD. In the first output period, a voltage value V (Sig+N_{FPN}) corresponding to the signal value S is held in SH1.

In the FPN measurement period, the amount of charges (N_{FPN}) corresponding to the signal value N are accumulated in the FD. In the second output period, a voltage value V (N_{FPN}) corresponding to the signal value N is held in SH2. In the readout period, the voltage value V (Sig) is output as the output (for example, the differential signal after the A/D conversion).

In the reset period, strictly speaking, noise caused by the reset driving is accumulated in the FD. The noise is considered to be sufficiently small as compared with the FPN, and thus the noise is omitted in the present embodiment.

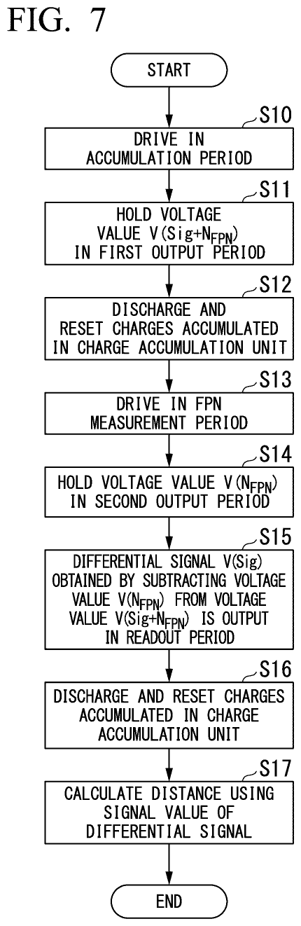

Here, a flow of processing performed by the distance image capturing device 1 will be described with reference to FIG. 7. FIG. 7 is a flowchart showing a flow of processing performed by the distance image capturing device 1 according to the embodiment. FIG. 7 shows a flow of driving in the frame cycle.

Step S10: The distance image capturing device 1 is driven in the accumulation period. The distance image capturing device 1 receives the reflected light RL corresponding to the irradiation with the optical pulse PO and accumulates the charge corresponding to the received reflected light RL in the charge accumulation unit CS to perform the driving in the accumulation period. As a result, the charges corresponding to the reflected light RL are distributed and accumulated in any two charge accumulation units CS of the charge accumulation units CS1 to CS4 in the pixel 321. The distance image capturing device 1 repeatedly executes the driving in such an accumulation period only by the number of times of integration. As a result, the charges corresponding to the amount of charges (Sig+N_{FPN}) are accumulated in each of the charge accumulation units CS.

Step S11: The distance image capturing device 1 stores the amount of charges (Sig+N_{FPN}) accumulated in each of the charge accumulation units CS in the memory by holding the amount of charges (Sig+N_{FPN}) in the shift register in the first output period.

Step S12: The distance image capturing device 1 performs a reset by discharging the charges accumulated in the charge accumulation unit CS in the reset period.

Step S13: The distance image capturing device 1 is driven in the FPN measurement period. The distance image capturing device 1 performs driving in the FPN measurement period by turning off all the readout gate transistors G1 to G4 and turning on (On) the drain gate transistor GD for the same time as the accumulation period. As a result, the charges corresponding to the amount of charges (N_{FPN}) are accumulated in each of the charge accumulation units CS.

Step S14: The distance image capturing device 1 stores the amount of charges (N_{FPN}) accumulated in each of the charge accumulation units CS in the memory by holding the amount of charges (N_{FPN}) in the shift register in the second output period.

Step S15: The distance image capturing device 1 outputs a differential signal V (Sig) obtained by subtracting the voltage value V (N_{FPN}) held in Step S14 from the voltage value V (Sig+N_{FPN}) held in Step S11 in the readout period.

Step S16: The distance image capturing device 1 performs a reset by discharging the charges accumulated in the charge accumulation unit CS in the reset period.

Step S17: The distance image capturing device 1 calculates the distance by using the differential signal V (Sig) output in step S15.

As described above, the distance image capturing device 1 according to the embodiment includes the light source unit 2, the light receiving unit 3, and the distance calculation unit 42. The light source unit 2 irradiates the subject OB with the optical pulse PO. The light receiving unit 3 includes a distance image sensor 32 (pixel circuit) in which a plurality of pixels 321 including a photoelectric conversion element PD, a drain gate transistor GD, and a plurality of charge accumulation units CS are arranged in a two-dimensional matrix shape, and a vertical scanning circuit 323 (pixel driving circuit). The photoelectric conversion element PD generates the charges according to the incident light. The drain gate transistor GD discharges the charges. The charge accumulation unit CS accumulates the charges. The vertical scanning circuit 323 distributes and accumulates the charges in each of the charge accumulation units CS at the accumulation timing synchronized with the irradiation with the optical pulse PO in the frame cycle, and discharges the charges to the drain gate transistor GD in a period other than the accumulation timing. The distance calculation unit 42 calculates the distance to the subject OB based on the amount of charges accumulated in each of the charge accumulation units CS. The frame cycle includes the accumulation period, the first output period, the FPN measurement period, the second output period, and the readout period. The accumulation period is a period in which the reflected light RL of the optical pulse PO is accumulated in the charge accumulation unit CS. The first output period is a period in which a voltage value (first voltage value) corresponding to the amount of charges accumulated in each of the charge accumulation units CS in the accumulation period is output. The FPN measurement period is a period in which the optical pulse PO is not emitted. The FPN measurement period is a period in which fixed pattern noise (FPN) is measured. The second output period is a period in which a voltage value (second voltage value) corresponding to the amount of charges accumulated in each of the charge accumulation units CS in the FPN measurement period is output. The readout period is a period in which a differential signal corresponding to a difference between the first voltage value and the second voltage value is output. The distance calculation unit 42 calculates the distance to the subject OB by using the signal value of the differential signal. As a result, in the distance image capturing device 1 of the embodiment, the FPN can be measured for each frame. Therefore, it is possible to accurately calculate the distance even in a case where the FPN fluctuates depending on the situation of the device.

In addition, in the distance image capturing device 1 of the embodiment, the vertical scanning circuit 323 (pixel driving circuit) discharges the charges to the drain gate transistor GD (charge discharge unit) without distributing and accumulating the charges in each of the charge accumulation units CS in the FPN measurement period. As a result, in the distance image capturing device 1 of the embodiment, the noise amount corresponding to the FPN can be accurately measured.

In addition, in the distance image capturing device 1 of the embodiment, each period of the accumulation period and the FPN measurement period is equal in length. As a result, in the distance image capturing device 1 of the embodiment, the FPN mixed in the charge accumulation unit CS in the accumulation period can be accurately measured in the FPN measurement period. In addition, the FPN mixed in the charge accumulation unit CS in the accumulation period can be removed by simple calculation.

All or a part of the distance image capturing device 1 and the distance image processing unit 4 in the above-described embodiment may be implemented by a computer. In this case, a program for implementing the functions may be recorded on a computer-readable recording medium, and a computer system may read and execute the program recorded on the recording medium to implement the functions. The term “computer system” here includes an OS and hardware such as a peripheral device. In addition, the term “computer-readable recording medium” refers to a portable medium such as a flexible disk, a magneto-optical disk, a ROM, or a CD-ROM, and a storage device such as a hard disk built into a computer system. Furthermore, the term “computer-readable recording medium” may include a medium that dynamically holds the program for a short period, such as a communication line for transmitting the program via networks such as the Internet and communication lines such as telephone lines, and a medium that holds a program for a certain period, such as a volatile memory inside a computer system that is a server or a client in that case. In addition, the program may be configured to implement a part of the above-described function, may be configured to implement the above-described function by combination with the program recorded in advance in a computer system, or may be configured to implement the program by using a programmable logic device such as FPGA.

Although the embodiments of the invention have been described in detail with reference to the drawings, the specific configuration is not limited to these embodiments, and design and the like are included within the scope of the gist of the present invention.

### INDUSTRIAL APPLICABILITY

According to the present invention, it is possible to calculate the distance with high accuracy even in a case where the FPN fluctuates depending on the situation of the device.

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: Distance image capturing device
2: Light source unit
3: Light receiving unit
32: Distance image sensor
321: Pixel (pixel circuit)
4: Distance image processing unit
42: Distance calculation unit
CS: Charge accumulation unit
PO: Optical pulse
RL: Reflected light

What is claimed is:

1. A distance image capturing device comprising:
a light source unit configured to irradiate a subject with an optical pulse;
a light receiving unit configured to include a pixel circuit in which a plurality of pixels, each of which has a photoelectric conversion element configured to generate a charge according to incident light, a charge discharge unit configured to discharge the charge, and a plurality of charge accumulation units configured to accumulate the charge, are arranged in a two-dimensional matrix shape, and a pixel driving circuit configured to distribute and accumulate the charge in each of the charge accumulation units at an accumulation timing synchronized with an irradiation with the optical pulse in a frame cycle, and discharge the charge to the charge discharge unit in a period other than the accumulation timing; and
a distance calculation unit configured to calculate a distance to the subject based on an amount of charges accumulated in each of the charge accumulation units, wherein
the frame cycle includes
an accumulation period in which reflected light of the optical pulse is accumulated in the charge accumulation unit,
a first output period in which a first voltage value corresponding to the amount of charges accumulated in the charge accumulation unit in the accumulation period is output,
an FPN measurement period in which a fixed pattern noise accumulated in the charge accumulation unit is measured,
a second output period in which a second voltage value corresponding to the amount of charges accumulated in the charge accumulation unit in the FPN measurement period is output, and
a readout period in which a differential signal corresponding to a difference between the first voltage value and the second voltage value is output, and
the distance calculation unit calculates the distance to the subject using a signal value of the differential signal.

2. The distance image capturing device according to claim 1, wherein
the pixel driving circuit discharges the charge to the charge discharge unit without distributing and accumulating the charge in each of the charge accumulation units in the FPN measurement period.

3. The distance image capturing device according to claim 1, wherein
each period of the accumulation period and the FPN measurement period is equal in length.

4. A distance image capturing method performed by a distance image capturing device including a light source unit configured to irradiate a subject with an optical pulse, a light receiving unit configured to include a pixel circuit in which a plurality of pixels, each of which has a photoelectric conversion element configured to generate a charge according to incident light, a charge discharge unit configured to discharge the charge, and a plurality of charge accumulation units configured to accumulate the charge, are arranged in a two-dimensional matrix shape, and a pixel driving circuit configured to distribute and accumulate the charge in each of the charge accumulation units at an accumulation timing synchronized with an irradiation with the optical pulse in a frame cycle, and discharge the charge to the charge discharge unit in a period other than the accumulation timing, and a distance calculation unit configured to calculate a distance to the subject based on an amount of charges accumulated in each of the charge accumulation units, in which
the frame cycle includes
an accumulation period in which reflected light of the optical pulse is accumulated in the charge accumulation unit,
a first output period in which a first voltage value corresponding to the amount of charges accumulated in the charge accumulation unit in the accumulation period is output,
an FPN measurement period in which a fixed pattern noise accumulated in the charge accumulation unit is measured,
a second output period in which a second voltage value corresponding to the amount of charges accumulated in the charge accumulation unit in the FPN measurement period is output, and
a readout period in which a differential signal corresponding to a difference between the first voltage value and the second voltage value is output,
the distance image capturing method comprising:
via the distance calculation unit, calculating the distance to the subject using a signal value of the differential signal.
